(19) United States
(12) Patent Application Publication
(10) Pub. No.: US 2012/0251707 A1
(43) Pub. Date: Oct. 4, 2012

(54) ADHESIVES

(75) Inventors: Mario SCHOLZ, Gruendau (DE); Juergen Meyer, Stockstadt (DE); Horst Zeizinger, Hanau (DE); Pia Buckel, Bruchkoebel (DE)

(73) Assignee: EVONIK DEGUSSA GMBH, Essen (DE)

(21) Appl. No.: 13/459,925

(22) Filed: Apr. 30, 2012

Related U.S. Application Data
(63) Continuation of application No. 12/599,326, filed on Nov. 9, 2009, now abandoned.

(30) Foreign Application Priority Data
May 22, 2007 (DE) 10 2007 024 096.3

(51) Int. Cl. C09J 163/00; B05D 5/12; C08K 5/07

(52) U.S. Cl. 427/58; 523/454; 523/402

(57) ABSTRACT

The invention provides an adhesive comprising structurally modified, pyrogenically prepared silicas containing on their surface organosilane groups of the formula (I) SiCₙH₍₂ₙ₊₁₎, where n is 2 to 18. The invention further provides for the use of these structurally modified, pyrogenically prepared silicas in adhesives.

The invention provides adhesives which comprise structurally modified, pyrogenically prepared silicas. The invention further provides for the use of structurally modified, pyrogenically prepared silicas in adhesives.

An adhesive is defined as a non-metallic material which is able to join adherends by surface adhesion and internal strength. In the prior art there are numerous different adhesives known, the great majority of the adhesives used having a composition based on organic compounds. A distinction is made essentially between physically setting adhesives and chemically curing adhesives. The physically setting adhesives are those in which the final adhesive substance, frequently a polymer, is used as it is and then a physical process causes the adhesive to solidify.

Known accordingly, for example, are hotmelt adhesives, dispersion-based adhesives, wet adhesives containing organic solvents, and contact adhesives. A feature common to all of these types of adhesive is that first the adhesive is applied in a processable form and then solidification occurs as a result, for example, of evaporation of the solvent or of cooling.

In the case of the chemically curing adhesives, individual building blocks are applied and subsequently, by means of a chemical reaction of the individual building blocks, a new product is formed and undergoes solidification. Among the reactive adhesives a distinction is made between 2-component and 1-component systems. In the case of the 2-component systems, the adhesives are applied from separate constituents and solidify through a chemical reaction. In the case of 1-component adhesives, the adhesive cures in a chemical reaction, as a result of a change in the ambient conditions—for example, temperature increase, ingress of air, evaporation, moisture or atmospheric oxygen.

The group of the chemically curing adhesives includes, for example, cyanoacrylate adhesives, methyl meth-acrylate adhesives, anaerobically curing adhesives, radiation-curing adhesives, phenol-formaldehyde resin adhesives, silicones, silane-crosslinked polymer adhesives, polyimide adhesives, epoxy resin adhesives and polyurethane adhesives. An overview of the various adhesives can be found in Ullmann's Enzyklopädie der Chemie, 4th edition, volume 14, page 227 ff. (1997).

Also known is the use of different additives in adhesives; among others, for example, pyrogenic (fumed) silicas, which are effective thixotropic agents, are used in adhesives based on epoxy resins (Degussa Pigments brochure series (2001) Nos. 27 and 54).

Pyrogenically prepared silicas possessing silanized surfaces are known from the prior art. EP 0 672 731 A1 describes silanized silicas. The silicas described therein are also not structurally modified.

A disadvantage associated with the use of such silicas is that they can be used only at a low concentration, since otherwise the adhesive is thickened to such a great extent that it is no longer possible to ensure processability. This means that only small amounts of pyrogenic silicas can be used in the adhesives, and, therefore, the desired thixotropic effect is not adequately ensured.

This disadvantage is particularly significant when the aim is to achieve high levels of filling in the adhesives in order to improve properties, such as fracture toughness, impact strength, scratch and abrasion resistance, contraction characteristics, thermal expansion and thermal stability of the adhesive. In that situation it is only possible to add insufficient amounts of pyrogenic silicas, since the adhesive becomes too thick and can therefore no longer be processed.

The technical problem addressed by the invention is therefore that of providing adhesives into which fairly large amounts of pyrogenic silica can be incorporated, for the purpose of improving the rheological proper-ties, without thickening of the adhesive occurring, and with the adhesive remaining processable.

This technical problem is solved by means of an adhesive which comprises structurally modified, pyrogenically prepared silicas containing on their surface alkylsilyl groups of the type SiCₙH₂ₙ₊₁, where n is 2 to 18, preferably 5 to 16 and very preferably 8 or 16.

Silanized silicas are known from the prior-art DE 102 39 424 A1, where they are used in coating materials in order to improve the scratch resistance of the coating's surface. EP 0 672 731 A1 likewise discloses silanized pyrogenic silicas, but those silicas are not structurally modified and are used as thickeners for coating materials and resins.

It was surprisingly observed that the structurally modified, pyrogenically prepared silicas according to the invention do not cause any thickening in adhesives, contrary to the prior art described in EP 0 672 731 A1, but instead can be introduced in fairly large amounts into adhesive without a strongly thickening effect occurring. It has been found that it is more particularly the structural modification, in conjunction with the specific silanized groups, that is responsible for this effect being obtained.

Pyrogenically prepared silicas are typically prepared by means of high-temperature hydrolysis from silicon tetrachloride, hydrogen and oxygen.

Table 1 gives a description of hydrophilic silicon dioxides of this kind, prepared pyrogenically by means of flame hydrolysis, which can be used in accordance with the invention.

TABLE 1
Properties of pyrogenic silicas prior to silanization

| | | Aerosil | Aerosil | Aerosil | Aerosil | Aerosil | Aerosil | Aerosil | Aerosil |
|---|---|---|---|---|---|---|---|---|---|
| | | 90 | 130 | 150 | 200 | 300 | 380 | OX 50 | TT 600 |
| Attitude towards water | | hydrophilic | | | | | | | |
| Appearance | | loose white powder | | | | | | | |
| BET surface area¹) m²/g | | 90 ± 15 | 130 ± 25 | 150 ± 15 | 200 ± 25 | 300 ± 30 | 380 ± 30 | 50 ± 15 | 200 ± 50 |
| Average primary particle size nm | | 20 | 16 | 14 | 12 | 7 | 7 | 40 | 40 |
| Tapped density²) | | | | | | | | | |
| normal product | g/l | about 80 | about 50 | about 50 | about 50 | about 50 | about 50 | about 130 | about 60 |
| compacted product | g/l | — | about 120 | about 120 | about 120 | about 120 | about 120 | — | — |
| (suffix “V”) | | | | | | | | | |
| Loss on drying³) | % | <1.0 | <1.5 | <0.5⁹) | <1.5 | <1.5 | <1.5 | <1.5 | <2.5 |
| (2 hours at 1000° C.) | | | | | | | | | |
| on leaving the supply plant | | | | | | | | | |
| Loss on ignition⁴)⁷) | % | <1 | <1 | <1 | <1 | <2 | <2.5 | <1 | <2.5 |
| (2 hours at 1000° C.) | | | | | | | | | |
| pH⁵) (in 4% aqueous dispersion) | | 3.6-4.5 | 3.6-4.3 | 3.6-4.3 | 3.6-4.3 | 3.6-4.3 | 3.6-4.3 | 3.8-4.8 | 3.6-4.5 |
| SiO₂⁸) | % | >99.8 | >99.8 | >99.8 | >99.8 | >99.8 | >99.8 | >99.8 | >99.8 |
| Al₂O₃⁸) | % | <0.05 | <0.05 | <0.05 | <0.05 | <0.05 | <0.05 | <0.08 | <0.05 |
| Fe₂O₃⁸) | % | <0.003 | <0.003 | <0.003 | <0.003 | <0.003 | <0.003 | <0.01 | <0.003 |
| TiO₂⁸) | % | <0.03 | <0.03 | <0.03 | <0.03 | <0.03 | <0.03 | <0.03 | <0.03 |
| HCl⁸) ⁹) | % | <0.025 | <0.025 | <0.025 | <0.025 | <0.025 | <0.025 | <0.025 | <0.025 |
| Sieve residue⁶) | % | <0.05 | <0.05 | <0.05 | <0.05 | <0.05 | <0.05 | <0.2 | <0.05 |
| (Mocker method, 45 μm) | | | | | | | | | |

¹)DIN 66131
²)DIN ISO 787/XI, JIS K 5101/18 (unsieved)
³)DIN ISO 787/II, ASTM D 280, JIS K 5101/21
⁴)DIN 55 921, ASTM D 1208, JIS K 5101/23
⁵)DIN ISO 787/IX, ASTM D 1208, JIS K 5101/24
⁶)DIN ISO 787/XVIII, JIS K 5101/20
⁷)based on the substance dried at 105° C. for 2 hours
⁸)based on the substance calcined at 1000° C. for 2 hours
⁹)HCl content is a constituent of the loss on ignition

Pyrogenic silicas of this kind are known from, for example, DE 102 39 424 A1. Pyrogenic silicas are also described in Winnacker-Küchler, Chemische Technologie, volume 3 (1983), 4th edition, page 77 and in Ullmann's Enzyklopädie der technichen Chemie, 4th edition (1982), volume 21, page 462 ff.

The surface modification with organosilanes can be carried out by spraying the silicas first, if appropriate, with water and then with the surface modifier. The water used may have been acidified with an acid, hydrochloric acid for example, to a pH of 7 to 1. If two or more surface modifiers are used, they may be applied jointly, but separately, in succession, or as a mixture. The surface modifier or modifiers may be in solution in suitable solvents. When spraying is at an end, mixing may continue for a further 5 to 30 minutes.

The mixture is subsequently treated thermally at a temperature of 20 to 400° C. over a period of 0.1 to 6 hours. The thermal treatment may take place under inert gas, such as nitrogen, for example.

An alternative method of surface modification of the silicas can be carried out by treating the silicas with the surface modifier in vapour form and then thermally treating the mixture at a temperature of 50 to 800° C. over a period of 0.1 to 6 hours. The thermal treatment may take place under inert gas, such as nitrogen, for example.

The temperature treatment may also take place in a plurality of stages at different temperatures.

The surface modifier or modifiers can be applied using single-fluid, dual-fluid or ultrasonic nozzles.

The surface modification can be carried out continuously or batchwise in heatable mixers and dryers with spraying devices. Suitable apparatus may include, for example the following: ploughshare mixers, plate dryers, fluidized-bed dryers or fluid-bed dryers.

The structural modification of the silicas thus prepared takes place subsequently by means of mechanical action. Structural modification may if appropriate be followed by grinding. If appropriate, after the structural modification and/or grinding, a heat treatment may take place.

The structural modification may take place for example with a ball mill or with a continuously operating ball mill. Grinding may take place, for example, by means of an air-jet mill, toothed-disc mill or pinned-disc mill. Heat treatment may take place batchwise, in a drying oven, for example, or continuously, in a fluid bed or fluidized bed, for example. Heat treatment may take place under inert gas, nitrogen for example.

Any pyrogenically prepared silicas can be used, examples being those set out in Table 1. From Table 1, the pyrogenically prepared silicas Aerosil 200, Aerosil 150 and Aerosil 300 are preferred. Particularly preferred is the pyrogenically prepared silica Aerosil 200.

Table 2 below shows the physicochemical characteristics of a pyrogenically prepared silica silanized with hexadecyltrimethoxysilane, prior to structural modification.

TABLE 2
Properties of the silanized pyrogenic silica prior to structural modification

| Starting material | A 90 | A 130 | A 150 | A 200 | A 300 | A 380 | OX 50 | TT 600 |
|---|---|---|---|---|---|---|---|---|
| Average primary particle size | 20 | 16 | 14 | 12 | 7 | 7 | 40 | 40 |
| [nm] | | | | | | | | |
| BET surface area [m²/g] 1) | 40-90 | 60-130 | 75-150 | 100-200 | 150-300 | 200-380 | 20-50 | 100-250 |
| Tapped density [g/l] 2) | 40-140 | 40-140 | 40-140 | 40-140 | 40-140 | 40-140 | 40-140 | 40-140 |
| Loss on drying [%] 3) | <2 | <2 | <2 | <2 | <2 | <2 | <2 | <2 |
| Loss on ignition [%] 4), 7) | 0.1-10 | 0.1-10 | 0.1-10 | 0.5-15 | 0.5-20 | 0.5-25 | 0.1-10 | 0.1-20 |
| Carbon content [%] | 0.1-10 | 0.1-10 | 0.1-10 | 0.5-15 | 0.5-20 | 0.1-25 | 0.1-10 | 0.5-20 |
| pH 5) | 3.5-5.5 | 3.5-5.5 | 3.5-5.5 | 3.5-5.5 | 3.5-5.5 | 3.5-5.5 | 3.5-5.5 | 3.5-5.5 |

1) DIN 66131
2) DIN ISO 787/XI, JIS K 5101/18 (unsieved)
3) DIN ISO 787/II, ASTM D 280, JIS K 5101/21
4) DIN 55 921, ASTM D 1208, JIS K 5101/23
5) DIN ISO 787/IX, ASTM D 1208, JIS K 5101/24
6) DIN ISO 787/XVIII, JIS K 5101/20
7) based on the substance dried at 105° C. for 2 hours
8) based on the substance calcined at 1000° C. for 2 hours
9) HCl content is a constituent of the loss on ignition

In one preferred embodiment the adhesive of the invention contains 1% to 40%, preferably 2% to 30% and more preferably 4% to 10% by weight of the structurally modified, pyrogenically prepared silica.

In one preferred embodiment the adhesive comprises as its base polymer compounds selected from the group consisting of epoxy resins, unsaturated polyester resins, polyurethane, silane-terminated polymers, vinyl ester resins, acrylates, polyvinyl acetate, polyvinyl alcohol, polyvinyl ethers, ethylene-vinyl acetate, ethylene-acrylic acid copolymers, polyvinyl acetates, polystyrene, polyvinyl chloride, styrene-butadiene rubber, chloroprene rubber, nitrile rubber, butyl rubber, polysulphide, polyethylene, polypropylene, fluorinated hydrocarbons, polyamides, saturated poly-esters and copolyesters, phenol-formaldehyde resins, cresol-/resorcinol-formaldehyde resins, urea-formaldehyde resins, melamine-formaldehyde resins, polyimides, polybenzimidazoles, polysulphones or mixtures thereof.

In one preferred embodiment the structurally modified, pyrogenically prepared silica can also be introduced into an epoxy resin, with this resin then being admixed to the adhesive.

Adhesives are products which, in accordance with their respective chemical composition and the physical state prevailing at the time of application to the adherends, allow wetting of the surfaces and, in their bonded joint, form the adhesive layer needed for the transmission of force between the adherends. Like sealants, adhesives comprise similar components in addition to the base polymer, such as, for example, solvents (ketones for example), water, fillers (chalk for example), thixotropic agents (pyrogenic silica for example), adhesion promoters (silanes for example), colour pastes (pigment-grade carbon black for example) and also further additives (for example, catalysts, ageing inhibitors).

In comparison to sealants, adhesives have higher tensile shear strengths and lower extension values; in other words, adhesives are hard to elastic, and sealants are elastic to plastic.

Epoxy resins are used preferably as base polymers for adhesives. Epoxy resins are prepared for example by condensing 2,2-bis(4-hydroxyphenyl)propane and epichlorohydrin in a basic medium. Depending on the equivalents of both reactants that are employed, the products are glycidyl ethers with different molar masses. In recent years, epoxy resins from bisphenol F, novolak epoxy resins, and cycloaliphatic and heterocyclic epoxy resins have also acquired importance.

Since epoxy resins on their own are poor film formers, molecular enlargement is required by means of suitable crosslinking agents. Examples of crosslinking agents used for epoxy resins include polyamines, polyamino-amides, carboxylic anhydrides and dicyandiamides. Among the amine curing agents a distinction is made between aliphatic, cycloaliphatic, aromatic and araliphatic polyamines. Curing takes place without elimination of reaction products. It generally involves the addition of a reactive hydrogen atom to the epoxide group, with formation of a hydroxyl group.

Unsaturated polyester resins are used preferably as base polymers for adhesives. They are obtained by polycondensation of unsaturated and saturated dicarboxylic or polycarboxylic acids with alcohols. Given a suitable reaction regime, the double bonds remain in the acid and/or alcohol and permit polymerization reactions with unsaturated monomers, styrene for example. Unsaturated dicarboxylic acids used with preference are as follows: maleic anhydride, maleic acid, fumaric acid.

Saturated dicarboxylic acids used with preference are as follows: ortho-phthalic acid and ortho-phthalic anhydride, isophthalic acid, terephthalic acid, tetra-hydrophthalic acid, hexahydrophthalic acid, adipic acid, azelaic acid, sebacic acid, hexachloroendo-methylenetetrahydrophthalic acid, tetrabromophthalic acid.

Glycols used with preference are as follows: propylene 1,2-glycol, ethylene glycol, butylene glycol, neopentyl glycol, 2,2,4-trimethylpentane-1,3-diol, dibromoneo-pentyl glycol, diethylene glycol, triethylene glycol, dipropylene glycol, pentaerythritol diallyl ether, dicyclopentadiene.

Monomers for the crosslinking used with preference are as follows: styrene, alpha-methylstyrene, meta- and para-methylstyrene, methyl methacrylate, diallyl phthalate, triallyl cyanurate.

This listing does not exhaust the number of possible starting materials. The skilled person will be able, depending on the raw material situation, to use other compounds as well. Furthermore, the addition of dicyclopentadiene is customary, and the reactivity of the resins is modified as a result. The “unsaturated polyester resins” produced can be used as such or in dilution with reactive monomers. Reactive monomers are styrene, stilbene, esters of acrylic acid, esters of methacrylic acid, diallyl phthalate, and other unsaturated compounds, provided that they have a sufficiently low viscosity and adequate miscibility with the unsaturated polyester resin.

Polyurethane resins are used preferably as base polymers for adhesives. The polyurethanes are derived from isocyanic acid. As an extremely reactive compound, it undergoes addition very readily with compounds which possess an active hydrogen atom. In the course of this reaction the double bond between the nitrogen and the carbon is cleaved, the active hydrogen becoming attached to the nitrogen and the oxygen-combining radical to the carbon, to form a urethane group. In order to obtain higher molecular mass crosslinked polyurethanes of the kind needed for adhesive and sealant layers, it is necessary to provide reaction partners which are starting products having at least two functional groups, such as di- or triisocyanates, for example diphenylmethane 4,4-diisocyanate (MDI) with polymeric fractions, or reaction product of tolylene diisocyanate (TDI) and polyols, and polyhydric alcohols (diols or polyols, compounds having two or more hydroxyl functions in the molecule). Alcohols of this kind may also be present, for example, in the form of saturated polyesters, which are prepared with an excess of polyalcohols.

Two-component reactive adhesives are composed of a low molecular mass polyisocyanate and a likewise relatively low molecular mass polyesterpolyol, for example polyalkylene polyadipate. Following the combining of the two components, urethane groups are formed in the adhesive or in the adhesive layer.

One-component reactive adhesives are composed of a relatively high molecular mass polyurethane, which sets by reacting with atmospheric moisture. In principle the situation here as well is one of two inter-reacting chemical components, but only one physical component is supplied for adhesive processing. Since, on reaction with moisture, the simple low molecular mass polyisocyanates form relatively hard and brittle adhesive layers with low strength values, the one-component systems start from precrosslinked polymers, known as prepolymers. These compounds are prepared from relatively high molecular mass polyols with a stoichiometric excess of isocyanate. In this way, the compounds present already possess urethane bonds, but in addition possess reactive isocyanate groups as well, which are amenable to the reaction with moisture. The reaction with water proceeds with the formation of a urea bond. The primary amines formed in the course of the decomposition reaction react immediately with further isocyanate groups to form polyureas. In the case of the one-component systems, therefore, the fully cured polymer contains not only urethane compounds but also urea compounds.

Solvent-borne polyurethane adhesives are available as physically setting systems and as chemically reacting systems. In the case of the physically setting systems the polymer takes the form of a high molecular mass hydroxyl polyurethane, the solvent used being, for example, methyl ethyl ketone. The chemically reacting systems include additionally hydroxyl polyurethane and a further polyisocyanate as crosslinker and as a second component.

Dispersion-based adhesives comprise a high molecular mass polyurethane in dispersion in water.

In the case of thermally activable polyurethane adhesives the isocyanate component is in “capped” or “blocked” form in a compound which eliminates the isocyanate component only at a relatively high temperature.

Reactive polyurethane hotmelt adhesives are prepared by using relatively high molecular mass, crystallizing and meltable diol and isocyanate components. These components are applied as hotmelt adhesives at temperatures from around 70° C. to 120° C. to the adherends. After cooling, the bond acquires a sufficient initial strength, which allows rapid further processing. Subsequently, as a result of additional moisture exposure of the reactive isocyanate groups still present, crosslinking then takes place via urea bonds, to form the adhesive layer polymer.

Silane-terminated polymers are used preferably as base polymers for adhesives.

The term “silane-terminated polymers” or else “silane-modified polymers” embraces all of those prepolymers which, either at the chain ends or pendently, carry silyl groups having at least one hydrolysable bond, but whose polymer backbone does not contain the siloxane bond typical of siloxanes.

In general it can be assumed that any silane-modified polymer, irrespective of its chemical structure, will have the qualities of a hybrid: the curing is similar to that of the silicones, and the other properties are shaped by the various possible polymer backbones between the silyl groups. Silane-terminated or silane-modified polymers can be classed in terms of their structure between the polyurethanes and the silicones.

The synthesis of the silane-modified polymer encompasses a number of stages. The initial basis is dihydric or trihydric polyoxypropylene glycol, which is converted into the corresponding bisallyl compound. That compound is reacted to form the desired end product, bis(3-(methyldimethoxysilyl)propyl)polyoxy-propylene.

The silyl groups thereby introduced into the chains crosslink with one another via mechanisms of the kind known in silicone chemistry, i.e., with elimination of small amounts of water or methanol, and so give an elastic and insoluble network.

There are further possible methods of obtaining sealants and adhesives based on silicone-modified polymers: for example, the reaction of NCO-terminated prepolymers with correspondingly reactive aminosilanes or mercaptosilanes. The polymer backbone may contain all of the conceivable rational structural elements, such as ether, ester, thioether or disulphide bridges. The converse case, in which an NH₂-, SH- or OH-terminated prepolymer can be reacted with an isocyanate silane, is likewise conceivable. The addition of terminal mercapto groups either in the prepolymer or in the silane to C—C double bonds offers a further route of technical interest.

Vinyl ester resins are used preferably as base polymers for adhesives. On the chemical side, vinyl ester resins possess a certain relationship to the UP resins, in particular as far as curing reaction, processing technology and field of use are concerned. These resins are polyadducts of liquid epoxy resins and acrylic acid. As a result of reduction of ester groups in the molecule chain, these resins have better hydrolysis resistance in tandem with effective elasticity and impact toughness. Monomers used for crosslinking are the same as for the unsaturated polyester resins, styrene in particular.

Acrylates are used preferably as base polymers for adhesives. The collective term “acrylate-based adhesives” encompasses all of the reactive adhesives whose curing takes place via the carbon-carbon double bond of the acrylic group.

Particular significance in adhesive formulations has been acquired by the methacrylic esters and the alpha-cyanoacrylic esters. The curing of the acrylate adhesives is accomplished by addition polymerization, in the course of which an initiator triggers a chain reaction leading to a continuous curing of adhesive. The polymerization of the “acrylate” adhesives can be initiated by means of free radicals or alternatively, in the case of the alpha-cyanoacrylates, by means of anions. In accordance with the polymerization mechanism that is utilized for curing, the acrylate adhesives are also subdivided into the following groups:

anionically curing adhesives: alpha-cyanoacrylate 1-component adhesives, free-radically curing adhesives: anaerobic 1-component adhesives, free-radically curing adhesives: 2-component adhesives

In the case of the sealants based on polyacrylic esters or acrylic ester copolymers and polymethacrylic esters a distinction is made between solvent-borne and aqueous systems. Polyacrylate sealants cure physically by evaporation of the solvent or of the dispersion water.

Polyvinyl acetates are used preferably as base polymers for adhesives. Polyvinyl acetate is the product of polymerization of vinyl acetate. Owing to the strongly polar acetate group present in the molecule, polyvinyl acetate possesses very good adhesion properties to many adherend surfaces. Use is predominantly as a dispersion-based adhesive with a solids content of approximately 50% to 60%, in some cases also based on vinyl acetate copolymers (with vinyl chloride, for example).

Polyvinyl alcohols are used preferably as base polymers for adhesives.

Polyvinyl alcohol comes about as a product of hydrolysis of polyvinyl acetate and other similar polyesters. Depending on molecular weight, the polyvinyl alcohol takes the form of a liquid having a more or less high viscosity. It is used, for example, for bonding cellulosic materials, such as paper, cardboard, wood, etc., for example, and also as a protective colloid for stabilizing and increasing the setting rate of dispersion-based adhesives.

Polyvinyl ethers are used preferably as base polymers for adhesives. Among the polyvinyl ethers, the following three polymers in particular are of interest as base materials for adhesives: polyvinyl methyl ethers, polyvinyl ethyl ethers, polyvinyl isobutyl ethers

The polyvinyl ethers at moderate degrees of polymerization are tacky plasticizing resins possessed of very good adhesion properties to porous and smooth surfaces. Polyvinyl methyl ether is notable in particular for the fact that, owing to its water-solubility, it can be moistened again and therefore, for example, as a mixture with dextrin or animal glues, used as a gum on label papers, endows them with improved adhesion. On account of their permanent tackiness, polyvinyl ethers are also employed in pressure-sensitive adhesives.

Ethylene-vinyl acetates, a copolymer of ethylene and vinyl acetate, are used preferably as base polymers for adhesives. In the molecular structure the vinyl acetate molecules are incorporated randomly in the ethylene chain. While the elimination of acetic acid makes the polyvinyl acetate relatively unstable under temperature load, the copolymers with ethylene are significantly more resistant in terms of oxidation and thermal degradation. For this reason, EVA copolymers with an approximately 40% vinyl acetate fraction are among an important group of base hotmelt adhesive materials.

Ethylene-acrylic acid copolymers are used preferably as base polymers for adhesives. They are copolymers of ethylene and of acrylic acid and/or acrylic esters.

These copolymers, which combine the chemical resistance of polyethylene with the good properties of the acid and/or ester moiety, represent important base polymers for hotmelt adhesives. The ester component used is preferably ethyl acrylate.

Polyvinylacetals are used preferably as base polymers for adhesives. Polyvinylacetals come about through the action of aldehydes on alcohols. The most important acetals for adhesives manufacture are polyvinylformal and polyvinylbutyral. Both serve as a plasticizing component for phenolic resin-based adhesives. Polyvinylbutyral, moreover, finds application as an adhesive film in laminated safety glass.

Polystyrenes are used preferably as base polymers for adhesives. The monomer is in use as a constituent for adhesive base materials predominantly in two areas: as a copolymer with plasticizing monomers, particularly butadiene, for the preparation of styrene-butadiene dispersions; and as a “polymerizable” solvent for copolymerization with unsaturated polyesters.

Polyvinyl chloride is used preferably as base polymer for adhesives. It is used more particularly for plastisol adhesives, and also as a copolymer with vinyl acetate to give vinyl chloride/vinyl acetate copolymers in solvent-based adhesives, dispersion-based adhesives, heat-sealing adhesives, and as a high-frequency welding assistant.

Styrene-butadiene rubber is used preferably as base polymer for adhesives. Styrene-butadiene rubber is a typical example of a thermoplastic elastomer, combining the application properties of elastomers with those of thermoplastics. The styrene-butadiene copolymer (SBS) and the styrene-isoprene copolymer (SIS) are what are called triblock copolymers, constructed linearly of successive identical monomer units in individual blocks. The end blocks are polystyrene segments, while the middle block is polybutadiene (styrene-butadiene-styrene block copolymer, SBS) or else isoprene (styrene-isoprene-styrene block polymer, SIS).

The ratio of styrene fraction to butadiene fraction or of styrene fraction to isoprene fraction is approximately 1:3. Unlike adhesive layer polymers which owe their elastic properties to the addition of plasticizer, in this way an “internal plasticizing” is achieved. A particular advantage of these rubber copolymers is their ability to form adhesive layers having good adhesion properties and high flexibility. Significant application therefore exists in situations where the adhesively bonded adherends are subject in practical use to high deformation stresses, such as in footwear or with rubber/rubber or rubber/metal bonds, for example.

Chloroprene rubber (CR) is used preferably as base polymer for adhesives. Chloroprene rubber (polychloroprene) comes about as a polymerization product and copolymerization product of chloroprene (2-chloro-butadiene). Besides the good adhesion properties, the linear macromolecules possess a strong propensity towards crystallization, which contributes to a relatively high strength on the part of the adhesive layer. These polymers and copolymers are important base materials for contact adhesives. The double bond present within the polychloroprene molecule allows additional crosslinking to be carried out with correspondingly reactive molecule groups. Thermosetting components used for this purpose include isocyanates and phenolic resins.

Nitrile rubber (NBR) is used preferably as base polymer for adhesives. Nitrile rubber is a copolymer of butadiene with a fraction of approximately 20% to 40% of acrylonitrile. The high acrylonitrile fraction endows these polymers with effective plasticizer resistance, so making them highly suitable, for example, for the bonding of plasticized plastics.

Butyl rubber is used preferably as base polymer for adhesives. Butyl rubber is a copolymer composed of a predominant fraction of isobutylene with isoprene. Within this linear chain molecule there exist, in the form of the long polyisobutylene segments, very high chain fractions of saturated character, at which no further crosslinking is possible. The sole crosslinkable component is the isoprene molecule, and so the overall properties of the butyl rubber are determined by the fraction of the number of double bonds, predetermined by the isoprene. The reactivity can be further influenced by incorporation of monomers containing chlorine or bromine.

Polysulphides are used preferably as base polymers for adhesives. Raw materials for polysulphide sealants have long been known under the trade name Thiokol®. Polysulphide polymers are obtained by reacting dichloroethylformal with sodium polysulphide. The molecular weight of the liquid polymers is between 3000 and 4000. By reaction with an oxidizing agent, manganese dioxide for example, they can be converted into an ultimate rubber-elastic state.

Polyethylenes are used preferably as base polymers for adhesives. The low molecular mass types, with melt indices in the range from 2 to 2000 g/10 min, have found use, in combination with tackifying resins and microwaxes, as hotmelt adhesives in the paper and cardboard industry.

Polypropylenes are used preferably as base polymers for adhesives. Polypropylene is in use as a base material for hotmelt adhesives with moderate strength properties, more specifically in the form of atactic polypropylene.

Fluorinated hydrocarbons are used preferably as base polymers for adhesives. Polyfluoro-ethylene-propylene is a copolymer of tetrafluoroethylene and hexafluoro-propylene and has been studied as a base material for hotmelt adhesives. The advantage of these products lies in the high long-term temperature durability.

Polyamides are used preferably as base polymers for adhesives. The polyamides represent some of the most important base materials for the physically setting hotmelt adhesives. Suitable for the preparation of the polyamides are the reactions described below, which typically take place in the melt under a nitrogen atmosphere: polycondensation of diamines with dicarboxylic acids; polycondensation of aminocarboxylic acids; polycondensation from lactams; polycondensation of diamines with dimerized fatty acids.

Saturated polyesters and copolyesters are used preferably as base polymers for adhesives. Saturated polyesters and copolyesters come about through polycondensation from dicarboxylic acids and diols. They are an important base material for hotmelt adhesives.

Phenol-formaldehyde resins are used preferably as base polymers for adhesives. These polymers come about through a polycondensation reaction between phenol and formaldehyde, forming highly crosslinked phenolic resins which are used as a base material for adhesives for—for example—aircraft construction. Pure phenol-formaldehyde resins are generally too brittle. For this reason they are modified with thermoplastic polymers by copolymerization or cocondensation, for example with polyvinylformal, polyvinylbutyral, polyamides, epoxy resins or elastomers, for example polychloroprene and nitrile rubber.

Cresol-/resorcinol-formaldehyde resins are used preferably as base polymers for adhesives. Besides phenol as a starting monomer for formaldehyde condensations, use is also made of phenol derivatives, such as cresols and resorcinol, as co-reactants.

Urea-formaldehyde resins are used preferably as base polymers for adhesives. A large number of nitrogen-containing organic compounds are capable of polycondensation with aldehydes. For application as adhesives, urea and melamine in particular have acquired importance. With the urea-formaldehyde resins the reaction sequence takes place initially in the form of an addition reaction in weakly acidic solution. The actual polycondensation reaction, leading to the formation of the polymeric adhesive layer, results in highly crosslinked polymers via the formation either of an ether bridge or of a methylene bridge.

Melamine-formaldehyde resins are used preferably as base polymers for adhesives. Like urea, melamine as well reacts with formaldehyde to form methylol compounds. As in the case of the urea reactions, the polycondensation with these compounds too proceeds via methylene or methylene ether linkages to form high molecular mass, highly crosslinked, hard and in some cases brittle adhesive layers.

Polyimides are used preferably as base polymers for adhesives. The experiments on the use of the polyimides arise out of the concern to have organically based adhesives available for high temperature challenges. The preparation of technically utilizable polyimides is accomplished by reaction of the anhydrides of tetrabasic acids, for example pyromellitic anhydride, with aromatic diamines, for example diaminodiphenyl oxide. Use as an adhesive is accomplished starting from a precondensate, in the form of solutions or films.

Polybenzimidazoles are used preferably as base polymers for adhesives.

The polybenzimidazoles are likewise to be classed as adhesives of high heat resistance. They come about through a polycondensation reaction from aromatic tetramines with dicarboxylic acid.

Polysulphones are used preferably as base polymers for adhesives. The polysulphones likewise belong to the group of heat-resistant adhesives. They are obtained, for example, through a polycondensation reaction from dihydroxydiphenyl sulphone with bisphenol A.

The adhesives of the invention are used preferably in casting compounds, which are used as a coating in the electrical and electronics industries.

It was surprising that the silicas described could be incorporated more rapidly into the adhesives of the invention and, despite high levels of filling, there were no disadvantages observed in respect of the viscosity and the processability of the adhesives.

The invention further provides for the use of structurally modified, pyrogenically prepared silicas containing on their surface alkylsilyl groups of the type SiCₙH₍₂ₙ₊₁₎ where n is 2 to 18, in adhesives.

The examples which follow are intended to elucidate the invention in greater detail.

### EXAMPLES

### Example 1

### Preparation of the Silanized Silica

The preparation is carried out using the pyrogenically prepared silicas, or silicas from Table 1. The organosilane used is hexadecyltrimethoxysilane (silane I). The silica is charged to a mixer and sprayed—with intense stirring—first with water and then with the organosilane. When spraying is at an end, mixing is continued for 15 to 30 minutes more, followed by heat treatment at 100 to 160° C. for 1 to 3 hours. The heat treatment may also take place under inert gas, such as nitrogen.

Table 3 below shows the reaction conditions of the individual silicas used from Table 1 for the silanization with hexadecyltrimethoxysilane. The physicochemical characteristics of the silanized silicas obtained can be found in the following Table 4.

TABLE 3
Reaction conditions for the silanization of the pyrogenic silica with hexadecyltrimethoxy-
silane

| | | Amount of | Amount of | Amount of | Heat | Heat |
|---|---|---|---|---|---|---|
| | | silane | water | ethanol | treatment | treatment |
| | | (g/100 g | (g/100 g | (g/100 g | time | temperature |
| Example | Silica | Aerosil) | Aerosil) | Aerosil) | (h) | (° C.) |
| 1 | AEROSIL ® 300 | 1 | 0 | 9 | 2 | 120 |
| 2 | AEROSIL ® 200 | 2.5 | 0 | 0 | 2 | 140 |
| 3 | AEROSIL ® 200 | 20 | 5 | 0 | 2 | 140 |
| 4 | AEROSIL ® 200 | 10 | 2.5 | 0 | 2 | 140 |
| 5 | AEROSIL ® 200 | 5 | 1.25 | 0 | 2 | 140 |
| 6 | AEROSIL ® 200 | 2.5 | 1.25 | 0 | 2 | 140 |

TABLE 4
Physicochemical characteristics of the silanized silicas obtained

| | | Tapped | Carbon | BET | Loss on | Loss on |
|---|---|---|---|---|---|---|
| | | density | content | surface area | drying | ignition |
| Example | pH 5) | (g/l) 2) | (%) | (m²/g) 1) | (%) 3) | (%) 4), 6) |
| 1 | 4.3 | 50 | 1.3 | 253 | 0.4 | 1.8 |
| 2 | 4.4 | 49 | 1.7 | 176 | 0.3 | 2.5 |
| 3 | 4.6 | 68 | 10.1 | 116 | 0.6 | 12.7 |
| 4 | 4.5 | 72 | 5.7 | 144 | 0.6 | 7.1 |
| 5 | 4.7 | 52 | 2.6 | 167 | 0.6 | 3.4 |
| 6 | 4.5 | 51 | 1.9 | 171 | 0.7 | 2.5 |

1) DIN 66131
2) DIN ISO 787/XI, JIS K 5101/18 (unsieved)
3) DIN ISO 787/II, ASTM D 280, JIS K 5101/21
4) DIN 55 921, ASTM D 1208, JIS K 5101/23
5) DIN ISO 787/IX, ASTM D 1208, JIS K 5101/24
6) based on the substance dried at 105° C. for 2 hours

### Example 2

### Structural Modification of the Silanized Silicas

The structural modification of the silanized silicas is accomplished by mechanical action in a continuously operating ball mill with optional subsequent grinding. Grinding may also be followed by heat treatment. Grinding is accomplished by means of an air-jet mill, toothed-disc mill or pin-disc mill. Heat treatment takes place batchwise in a drying oven or may take place continuously in a fluidized-bed or fluid-bed drier.

Tables 5 and 6 below describe the properties of the silicas used in the adhesives in comparison to corresponding comparison silicas.

TABLE 5
Overview of the preparation of the comparison silicas and
of the inventive silicas

| | | | | Heat |
|---|---|---|---|---|
| | | | Grinding after | treatment |
| | Surface-fixed | Structural | structural | after |
| Identification | group | modification | modification | grinding |
| Comparison | hexadecylsilyl | no | — | — |
| silica 1 | | | | |
| Comparison | octylsilyl | no | — | — |
| silica 2 | | | | |
| Silicas 1 | hexadecylsilyl | yes | no | no |
| Silicas 2 | octylsilyl | yes | yes | no |
| Silicas 3 | hexadecylsilyl | yes | yes | yes |
| Silicas 4 | octylsilyl | yes | no | yes |
| Silicas 5 | octylsilyl | yes | yes | no |
| Silicas 6 | hexadecylsilyl | yes | yes | no |
| Silicas 7 | hexadecylsilyl | yes | yes | no |
| Silicas 8 | hexadecylsilyl | yes | no | no |
| Silicas 9 | octylsilyl | yes | yes | no |
| Silicas 10 | octylsilyl | yes | no | no |
| Silicas 11 | octylsilyl | yes | yes | no |
| Silicas 12 | octylsilyl | yes | no | no |

TABLE 6
Physicochemical data of the inventive silicas (examples) and of the
comparison silicas

| | | | | | | | BET |
|---|---|---|---|---|---|---|---|
| | | | | | | DBP | specific |
| | Tapped | Loss on | Loss on | | C | adsorp- | surface |
| Identifi- | density | drying | ignition | | content | tion | area |
| cation | [g/l] | [%] | [%] | pH | [%] | [%] | [m²/g] |
| Com- | 57 | 0.5 | 1.8 | 4.6 | 1.2 | 302 | 195 |
| parison | | | | | | | |
| silica 1 | | | | | | | |
| Com- | 51 | 0.6 | 6.8 | 5.3 | 5.4 | 263 | 175 |
| parison | | | | | | | |
| silica 2 | | | | | | | |
| Silicas 1 | 137 | 0.7 | 1.9 | 4.9 | 1.3 | 217 | 193 |
| Silicas 2 | 112 | 0.7 | 7.0 | 5.8 | 5.5 | 145 | 175 |
| Silicas 3 | 118 | 0.7 | 2.3 | 5.1 | 1.3 | 228 | 176 |
| Silicas 4 | 163 | 0.9 | 6.7 | 5.3 | 5.4 | 134 | 176 |
| Silicas 5 | 114 | 0.5 | 7.1 | 6.0 | 5.4 | 142 | 175 |
| Silicas 6 | 113 | 1.3 | 2.2 | 5.1 | 1.4 | 221 | 193 |
| Silicas 7 | 123 | 0.7 | 2.6 | 6.0 | 1.4 | 208 | 197 |
| Silicas 9 | 146 | 1.1 | 2.3 | 5.8 | 1.4 | 182 | 195 |
| Silicas 9 | 240 | 0.8 | 6.7 | 4.8 | 5.3 | 87 | 169 |
| Silicas 10 | 322 | 0.3 | 6.9 | 6.0 | 5.3 | not | 172 |
| | | | | | | deter- | |
| | | | | | | minable | |
| Silicas 11 | 204 | 0.7 | 6.4 | 5.7 | 5.4 | 101 | 173 |
| Silicas 12 | 276 | 0.3 | 6.6 | 6.6 | 5.3 | not | 168 |
| | | | | | | deter- | |
| | | | | | | minable | |

### Example 3

### Rheological Properties

In the following Example 3 the rheological properties of the structurally modified, pyrogenic silicas used are determined in the epoxy resin Renlam M1 (Huntsman). The respective viscosities with comparison products and with the structurally modified silicas used in the invention are ascertained. The viscosities are measured before and after addition of the silica.

The determination of the rheological properties takes place in accordance with the method described below.

167.5 g of Renlam M-1 and 10 g of silica are weighed out into a 350 ml beaker and the dissolver disc is immersed completely. Then the silica is homogenized at a speed n1 of 1000 rpm, with the lid closed, until it has been fully incorporated. As soon as the silica has been fully incorporated, the speed is increased to n2=3000 rpm and dispersion is carried out for 3 minutes under vacuum. The viscosity is determined using a Brookfield DV III rheometer. The viscosity values reported were obtained at room temperature, 25° C. Measurement is made at 2.5 rpm using a No. 7 spindle.

Table 7 below shows the results.

TABLE 7

| | Viscosity at 25° C. | Initial mass of |
|---|---|---|
| Silica from | following addition | silica [g/% by |
| Table 6 | [mPas] | weight] |
| Comparison | 139 200 | 10/5.6 |
| silica 2 | | |
| Silica 4 | 15 200 | 10/5.6 |
| Comparison | 1 240 800 | 10/5.6 |
| silica 1 | | |
| Silica 1 | 24 320 | 10/5.6 |

From the table it is apparent that the viscosity of the comparison silicas 1 and 2 when added to the epoxy resin is very high. In comparison with this, the addition of the silicas 1 and 4 produces a marked reduction in the viscosity of the epoxy resin. The experiment shows that, even at high levels of filling, the rheological properties of the epoxy resins are not adversely affected and there is no thickening, as a person skilled in the art would have expected from the prior art.

1-9. (canceled)

10. An liquid adhesive comprising a base polymer, solvent and a structurally modified, pyrogenically prepared silica comprising on a surface thereof organosilane groups of formula (I):
SiCₙH₍₂ₙ₊₁₎,
wherein n=2 to 18.

11. The adhesive of claim 10, wherein the solvent is a ketone.

12. The adhesive of claim 10, wherein the base polymer comprises least one member selected from the group consisting of epoxy resin, unsaturated polyester resin, polyurethane, silane-terminated polymer, vinyl ester resin, acrylate, polyvinyl acetate, polyvinyl alcohol, polyvinyl ether, ethylene-vinyl acetate, ethylene-acrylic acid copolymer, polyvinyl acetate, polystyrene, polyvinyl chloride, styrene-butadiene rubber, chloroprene rubber, nitrile rubber, butyl rubber, polysulphide, polyethylene, polypropylene, fluorinated hydrocarbon, polyamide, saturated polyester, saturated copolyester, phenol-formaldehyde resin, cresol-/resorcinol-formaldehyde resin, urea-formaldehyde resin, melamine-formaldehyde resin, polyimide, polybenzimidazole, and polysulphone.

13. The adhesive of claim 10, wherein n is 5 to 16.

14. The adhesive of claim 10, wherein n is 8 or 16.

15. The adhesive of claim 10, which comprises 1% to 40% by weight of the structurally modified, pyrogenically prepared silica.

16. The adhesive of claim 10, which comprises the structurally modified, pyrogenically prepared silica in a casting compound of an epoxy resin, said compound admixed into the adhesive.

17. The adhesive of claim 10, further comprising one or more of water, fillers, thixotropic agents, adhesion promoters, color pastes, catalysts or ageing inhibitors.

18. A method of applying the adhesive of claim 10, comprising coating an electrical substrate with the adhesive.

19. The adhesive of claim 10, which contains 1% to 40% by weight of the structurally modified, pyrogenically prepared silica.

20. The adhesive of claim 10, which contains 2% to 30% by weight of the structurally modified, pyrogenically prepared silica.

21. The adhesive of claim 10, which contains 4% to 10% by weight of the structurally modified, pyrogenically prepared silica.
